(19) United States
(12) Patent Application Publication
(10) Pub. No.: US 2008/0050606 A1
(43) Pub. Date: Feb. 28, 2008

(54) Aluminum alloy plate for producing molded article which is to be subjected to bake coating

(75) Inventors: Hitoshi Kazama, Saitama (JP); Kunihiro Yasunaga, Saitama (JP)

Correspondence Address: ARENT FOX LLP, 1050 CONNECTICUT AVENUE, N.W., SUITE 400, WASHINGTON, DC, 20036, US

(73) Assignee: Honda Motor Co., Ltd.

(21) Appl. No.: 11/907,674

(22) Filed: Oct. 16, 2007

Related U.S. Application Data
(63) Continuation of application No. 10/800,032, filed on Mar. 15, 2004, now abandoned.

(30) Foreign Application Priority Data
Mar. 19, 2003 (JP) 2003-074920

(51) Int. Cl. B32B 15/01

(52) U.S. Cl. 428/544

(57) ABSTRACT

An aluminum alloy plate to be subjected to a bake coating contains silicon (Si) and magnesium (Mg) with the balance being aluminum (Al) and inevitable impurities. In order to set the content of Mg₂Si in a range of 0.50% by weight≦Mg₂Si≦1.00% by weight, when the Si content by weight percent is taken on an x-axis of rectangular coordinates and the Mg content by weight percent is taken on a y-axis of the rectangular coordinates, the Si and Mg contents are set in a region in a diagram formed by sequentially connecting a point A (0.18, 0.31), a point B (1.3, 0.31), a point C (1.3, 0.64), a point D (0.37, 0.64), a point E (0.37, 1.0), a point F (0.18, 1.0) and the point A (0.18, 0.31). Thus, a bake-hard effect can be obtained, and the aluminum alloy plate can be produced at a relatively low manufacturing cost.

### BACKGROUND OF THE INVENTION

1. Field of the Invention

The present invention relates to an aluminum alloy plate, and particularly to an aluminum alloy plate for producing a molded article which is to be subjected to a bake coating.

2. Description of the Related Art

This type of aluminum alloy plate includes, for example, an aluminum alloy plate for external and internal plates for an automobile, an aluminum alloy plate for exterior and interior plates for various devices and the like.

An aluminum alloy plate formed, for example, a 6,000-type alloy is conventionally employed as this type of aluminum alloy plate. The reason why such an aluminum alloy plate is employed is that the aluminum alloy plate has a good formability, because it is low in bearing strength and small in spring back during forming by a press, and on the other hand, it is possible to expect a bake-hard effect such that the plate has a desired bearing strength and a desired dent resistance in virtue of heat during bake-drying thereof after the bake coating.

If a rough surface called a ridging mark is produced on a molded article upon forming by a press, a pulled surface appears clearly after the coating to degrade the appearance quality of a product. Therefore, to avoid this, a predetermined means is taken (for example, see Japanese Patent Application Laid-open No. 11-189836).

However, to provide a bake-hard effect as described above, a homogenizing treatment and a hot rolling treatment comprising a hot rough rolling and a subsequent hot finish rolling must be carried out at an Al alloy plate-manufacturing stage. On the other hand, to suppress the generation of the ridging mark, a metallographic structure must be controlled by setting homogenizing conditions and hot rolling conditions strictly and employing an intermediate annealing step. Therefore, in the prior art, there is a problem that the number of manufacturing steps is large; an amount of energy consumed is large; and an increase in manufacture cost for the Al alloy plate is unavoidable.

### SUMMARY OF THE INVENTION

Accordingly, it is an object of at least some embodiments of the present invention to provide an Al alloy plate of the above-described type, wherein a bake-hard effect can be obtained, and a manufacturing cost is relatively low.

To achieve the above object, according to at least some embodiments of the present invention, there is provided an aluminum alloy plate which is used for producing a molded article to be subjected to a bake coating, and which contains silicon (Si) and magnesium (Mg) with the balance being aluminum (Al) inevitable impurities, wherein when the Si content by weight percent is taken on an x-axis of rectangular coordinates and the Mg content by weight percent is taken on a y-axis of the rectangular coordinates, the Si and Mg contents are set in a region in a diagram formed by sequentially connecting a point A (0.18, 0.31), a point B (1.3, 0.31), a point C (1.3, 0.64), a point D (0.37, 0.64), a point E (0.37, 1.0), a point F (0.18, 1.0) and the point A (0.18, 0.31).

If the Si and Mg contents are set as described above, a content of Mg₂Si can be set in a range of 0.5% by weight≦Mg₂Si≦1.00% by weight to provide an aluminum alloy plate which is low in bearing strength and small in spring-back during forming by a press, leading to an improved formability, and on the other hand, which ensures that it is possible to provide a bake-hard effect such that the aluminum alloy plate has a desired bearing strength and a desired dent resistance in virtue of a heat during a bake-drying thereof after a bake-coating, whereby the 0.2% bearing strength of a product, namely, a molded article can be increased to equal to or larger than 140 MPa. However, if the content of Mg₂Si is smaller than 0.50% by weight, the bake-hard effect is reduced. On the other hand, if Mg₂Si>1.00% by weight, the bearing strength is increased, resulting in a degradation in formability by the press and in a lower bake-hard effect.

In addition, according to at least some embodiments of the present invention, there is provided an aluminum alloy plate which is used for producing a molded article to be subjected to a bake coating, and which contains silicon (Si) and magnesium (Mg) as requisite chemical constituents and further contains at least one of Fe, Ti, B and Cr as an optional chemical constituent, with the balance being aluminum (Al) and inevitable impurities, wherein when the Si content by weight percent is taken on an x-axis of rectangular coordinates and the Mg content by weight percent is taken on a y-axis of the rectangular coordinates, the Si and Mg contents are set in a region in a diagram formed by sequentially connecting a point A (0.18, 0.31), a point B (1.3, 0.31), a point C (1.3, 0.64), a point D (0.37, 0.64), a point E (0.37, 1.0), a point F (0.18, 1.0) and the point A (0.18, 0.31); and the Fe content is set in a range of 0.2% by weight≦Fe≦0.6% by weight; the Ti content is set in a range of 0.01% by weight≦Ti≦0.2% by weight; the B content is set in a range of 0.0005% by weight≦B≦0.05% by weight; and the Cr content is set in a range of 0.03% by weight≦Cr≦0.2% by weight.

If the Si and Mg contents are set as described above, an effect similar to the above-described effect is obtained. If the contents of Fe and the like are set as described above in the Si and Mg contents set as described above, a crystal grain size d in a metallographic structure can be set at d≦20 μm to prevent (or suppress to the utmost) the generation of a ridging mark during forming by a press. However, if Fe<0.2% by weight, or Ti<0.01, or B<0.0005% by weight or Cr<0.03% by weight, the level of crystal grain pulverizing effect is low, and a ridging mark is liable to be generated depending on the degree of processing. On the other hand, if Fe>0.6% by weight, or Ti>0.2% by weight, or B>0.05% by weight or Cr>0.2% by weight, a rough and large intermetallic compound is precipitated, resulting in a degradation in formability by the press. Ti may be used alone or in combination with B.

Further, according to at least some embodiments of the present invention, there is provided an aluminum alloy plate which is used for producing a molded article to be subjected to a bake coating, and which contains silicon (Si), magnesium (Mg) and copper (Cu) as requisite chemical constituents and further contains at least one of Fe, Ti, B and Cr as an optional chemical constituent, with the balance being aluminum (Al) and inevitable impurities, wherein when the Si content by weight percent is taken on an x-axis of rectangular coordinates and the Mg content by weight percent is taken on a y-axis of the rectangular coordinates, the Si and Mg contents are set in a region in a diagram formed by sequentially connecting a point A (0.18, 0.31), a point B (1.3, 0.31), a point C (1.3, 0.64), a point D (0.37, 0.64), a point E (0.37, 1.0), a point F (0.18, 1.0) and the point A (0.18, 0.31); and the Cu content is set at Cu≦0.2% by weight; the Fe content is set in a range of 0.2% by weight≦Fe≦0.6% by weight; the Ti content is set in a range of 0.01% by weight≦Ti≦0.2% by weight; the B content is set in a range of 0.0005% by weight≦B≦0.05% by weight; and the Cr content is set in a range of 0.03% by weight≦Cr≦0.2% by weight.

If the Si and Fe contents are set as described above and the contents of Fe and the like are set as described above, an effect similar to the above-described effect is obtained. In addition, the strength of the Al alloy plate can be increased by the addition of Cu. However, if Cu>0.2% by weight, the corrosion resistance of the Al alloy plate is lowered and hence, the Al alloy plate is unsuitable as an Al alloy plate for an external plate of an automobile.

The characteristic ensuring that the bake-hard effect can be obtained and generation of the ridging mark can be suppressed as described above, is attributable mainly to the composition of the Al alloy plate. Therefore, it is possible to apply, to the manufacture of the Al alloy plate, a simple process in which a continuous casting capable of providing an effect of pulverizing a metallographic structure by quenching is employed, and cold rolling and thermal treatment are then carried out sequentially and hence, it is possible to reduce the cost of manufacturing the Al alloy plate.

Even if the contents of Fe and the like are set in the above-described ranges in the Al alloy plate having the above-described composition, there is a tendency that the crystal grain size d is smaller than 20 μm, when the Si and Mg contents deviate from the above-described ranges.

The above and other objects, features and advantages of the invention will become apparent from the following description of the preferred embodiment taken in conjunction with the accompanying drawings.

### BRIEF DESCRIPTION OF THE DRAWINGS

FIG. 1 is a graph showing the relationship between the Si and Mg contents;

FIG. 2 is a graph showing the relationship between the content of Mg₂Si and the 0.2% bearing strength;

FIG. 3 is a perspective view of a molded article; and

FIG. 4 is a sectional view taken along a line 4-4 in FIG. 3.

### DESCRIPTION OF THE PREFERRED EMBODIMENT

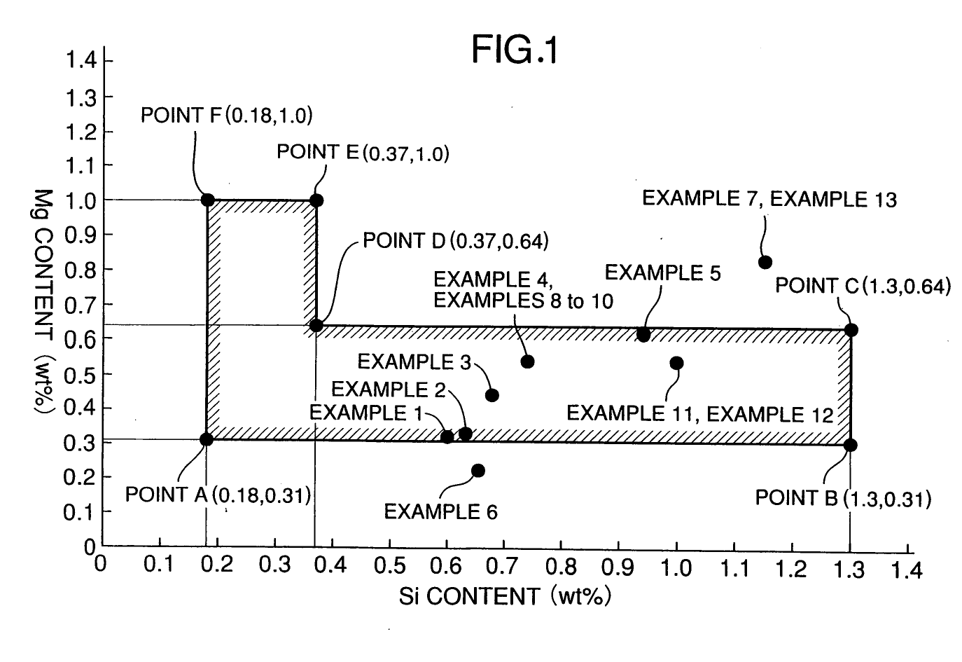

A plate of an aluminum alloy for producing a molded article which is to be subjected to a bake coating, e.g., an aluminum alloy plate for an external plate of an automobile is an aluminum alloy plate containing silicon (Si), magnesium (Mg) and the balance of aluminum including inevitable impurities, as shown in FIG. 1. When the Si content by weight percent is taken on an x-axis of rectangular coordinates and the Mg content by weight percent is taken on a y-axis, the Si and Mg contents are set in a range (including lines each connecting a point and a point to each other) in a diagram formed by sequentially connecting a point A (0.18, 0.31), a point B (1.3, 0.31), a point C (1.3, 0.64), a point D (0.37, 0.64), E a point (0.37, 1.0), a point F (0.18, 1.0) and the point A (0.18, 0.31).

The aluminum alloy plate includes an aluminum alloy plate which contains Si and Mg as requisite chemical constituents having contents set in a range as described above, and at least one of Fe, Ti, B and Cr as an optional chemical constituent, wherein the Fe content is set in a range of 0.2% by weight≦Fe≦0.6% by weight; the Ti content is set in a range of 0.01% by weight≦Ti≦0.2% by weight; the B content is set in a range of 0.0005% by weight≦B≦0.05% by weight; and the Cr content is set in a range of 0.003% by weight≦Cr≦0.2% by weight.

The aluminum alloy plate further includes an aluminum alloy plate which contains Si and Mg as requisite chemical constituents having contents set in a range as described above, and at least one of Fe, Ti, B and Cr as an optional chemical constituent, whose contents are set in ranges as described above, and which further contains copper (Cu) as a requisite chemical constituent, whose content is set at Cu≦0.2% by weight.

To produce the aluminum alloy plate, the following steps can, for example, be adopted: a step of preparing a molten metal having a composition as described above to produce a plate material under the application of a continuous casting process, a step of subjecting the plate material to cold rolling to provide a cold rolled plate, and a thermally treating step of sequentially subjecting the rolled plate to a solution treatment and a stabilizing thermal treatment. The aluminum alloy plate provided after the thermal treatment is subjected to a straightening treatment, as desired.

### Embodiment I

Table 1 shows compositions of examples 1 to 7 of aluminum alloys. The examples 1 to 7 are also shown in FIG. 1 based on Si and Mg contents.

TABLE 1

| | Chemical | | |
|---|---|---|---|
| | constituents (% by weight) | | |
| Al alloy | Si | Mg | Al |
| Example 1 | 0.60 | 0.32 | Balance |
| Example 2 | 0.63 | 0.34 | Balance |
| Example 3 | 0.68 | 0.45 | Balance |
| Example 4 | 0.74 | 0.55 | Balance |
| Example 5 | 0.89 | 0.63 | Balance |
| Example 6 | 0.65 | 0.23 | Balance |
| Example 7 | 1.15 | 0.83 | Balance |

A. Production of Al Alloy Plate

(1) A plate material having a thickness of 7 mm was produced under the application of a twin roll caster process (TRC) as a continuous casting process using a molten metal having the same composition as example 1 of the Al alloy.

(2) The plate material was subjected to 7 passes of a cold rolling treatment to provide a rolled plate having a thickness of 1 mm.

(3) The rolled plate was subjected to a thermal treatment including a solution treatment carried out under conditions of the employment of an infrared heating technique, a treating temperature of 560° C., a treating time of 30 seconds and a gas cooling, and a stabilizing thermal treatment then carried out under conditions of the employment of a muffle furnace, a treating temperature of 100° C., and a treating time of 8 hours, thereby providing a thermally treated plate.

(4) The thermally treated plate was subjected to a straightening treatment using a straightening machine to produce example 1 of an Al alloy plate.

Examples 2 to 7 of Al alloy plates were produced by a process similar to the above-described process using molten metals having the same compositions as the examples 2 to 7 of the aluminum alloys. The examples 2 to 7 correspond to the examples 2 to 7 of the aluminum alloys, respectively.

B. Calculation of Content of Mg₂Si and Measurement of Crystal Grain Size d

A content of Mg₂Si in each of the examples 1 to 7 of the Al alloy plates was calculated, and a crystal grain size d of each of the examples 1 to 7 of the Al alloy plates was measured. The measurement of the crystal grain size d was carried out in the order of polishing a test piece, then shooting a polished surface in a polarizing manner using a photomicroscope and then analyzing the photograph picture.

C. Bake-Hard Effect of Al Alloy Plate

A test piece of JIS No. 5 for a tensile test was fabricated from each of the examples 1 to 7 of the Al alloy plates and then subjected to a tensile test to determine a 0.2% bearing strength. Each of the fabricated test pieces was subjected to a heating treatment with a heating at 180° C. for 1 hour followed by air cooling on the assumption of a bake drying after a coating, and then subjected to a tensile test to determine a 0.2% bearing strength.

Table 2 shows contents of Mg₂Si, 0.2% bearing strengths (P₁), (P₂) before and after the heating, bake-hard amounts (P₂)-(P₁) and crystal grain sizes d for the examples 1 to 7 of the Al alloy plates.

TABLE 2

| | | 0.2% bearing | | | |
|---|---|---|---|---|---|
| | | strength (MPa) | | Bake-hard | Crystal |
| | Content of | Before | After | amount | grain |
| | Mg₂Si | heating | heating | (P₂) − (P₁) | size d |
| Al alloy plate | (% by weight) | (P₁) | (P₂) | (MPa) | (μm) |
| Example 1 | 0.51 | 100 | 141 | 41 | 30 |
| Example 2 | 0.54 | 102 | 148 | 46 | 25 |
| Example 3 | 0.71 | 109 | 162 | 53 | 28 |
| Example 4 | 0.87 | 106 | 163 | 57 | 30 |
| Example 5 | 0.99 | 132 | 172 | 40 | 26 |
| Example 6 | 0.36 | 103 | 115 | 12 | 27 |
| Example 7 | 1.31 | 148 | 177 | 29 | 26 |

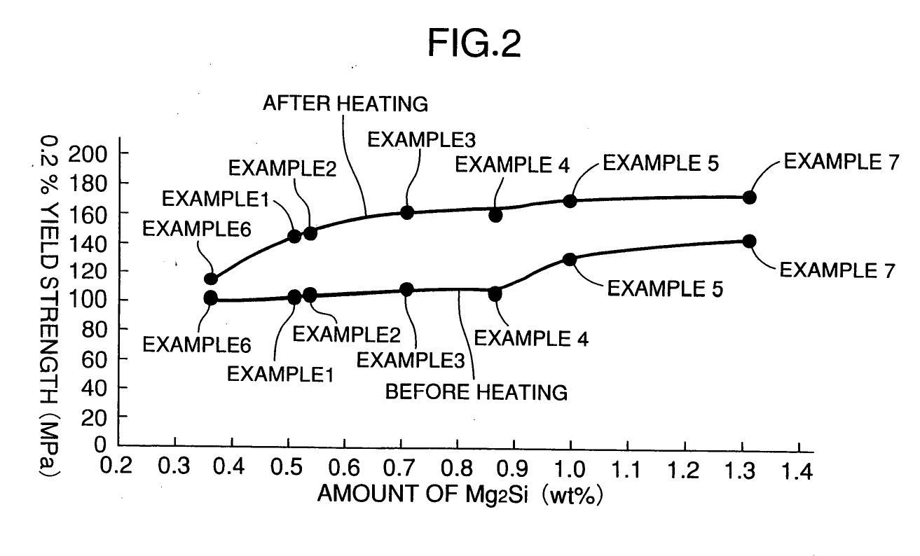

FIG. 2 is a graph made based on Table 2 and showing the relationship between the contents of Mg₂Si and the 0.2% bearing strengths before and after the heating the examples 1 to 7 of the Al alloy plates. As is apparent from FIG. 2, each of the examples 1 to 5 of the Al alloy plates has a low bearing strength and a good formability. On the other hand, it is possible to provide a bake-hard effect in that the bake-hard amount can be increased to equal to or larger than 41 MPa, and the 0.2% bearing strength can be increased to equal to or larger than 140 MPa after the heating, because the content of Mg₂Si was set in a range of 0.50% by weight≦Mg₂Si≦1.00% by weight. The example 6 of the Al alloy plate has a low bake-hard effect because of Mg₂Si<0.50% by weight, and the example 7 of the Al alloy plate has a high 0.2% bearing strength before the heating because of Mg₂Si>1.00% by weight and hence, has a poor formability by pressing and a low bake-hard effect. On the other hand, in each of the examples 1 to 7, the crystal grain size d is slightly large, because a crystal grain pulverizing means is not adopted.

### Embodiment II

Table 3 shows compositions of examples 8 to 13 of Al alloys. The examples 8 to 13 are also shown in FIG. 1 based on contents of Si and Mg.

TABLE 3

| | Chemical constituents (% by weight) | | | | | | | |
|---|---|---|---|---|---|---|---|---|
| Al alloy | Si | Mg | Cu | Fe | Cr | Ti | B | Al |
| Example 8 | 0.74 | 0.55 | — | 0.2 | 0.1 | 0.02 | — | Balance |
| Example 9 | 0.74 | 0.55 | 0.2 | 0.2 | 0.1 | 0.02 | — | Balance |
| Example 10 | 0.74 | 0.55 | — | 0.2 | 0.1 | 0.15 | 0.05 | Balance |
| Example 11 | 1.0 | 0.55 | — | 0.5 | — | 0.02 | — | Balance |
| Example 12 | 1.0 | 0.55 | — | 0.5 | — | 0.15 | 0.05 | Balance |
| Example 13 | 1.15 | 0.83 | — | 0.2 | — | 0.02 | — | Balance |

Examples 8 to 13 of Al alloy plates were produced in a process similar to the above-described process sequentially using the examples 8 to 13 of the Al alloys. These examples 8 to 13 correspond to the examples 8 to 13 of the Al alloys, respectively.

Content of Mg₂Si, crystal grain size d and 0.2% bearing strength for each of the examples 8 to 13 of the Al alloy plates were measured by a method similar to the above-described method.

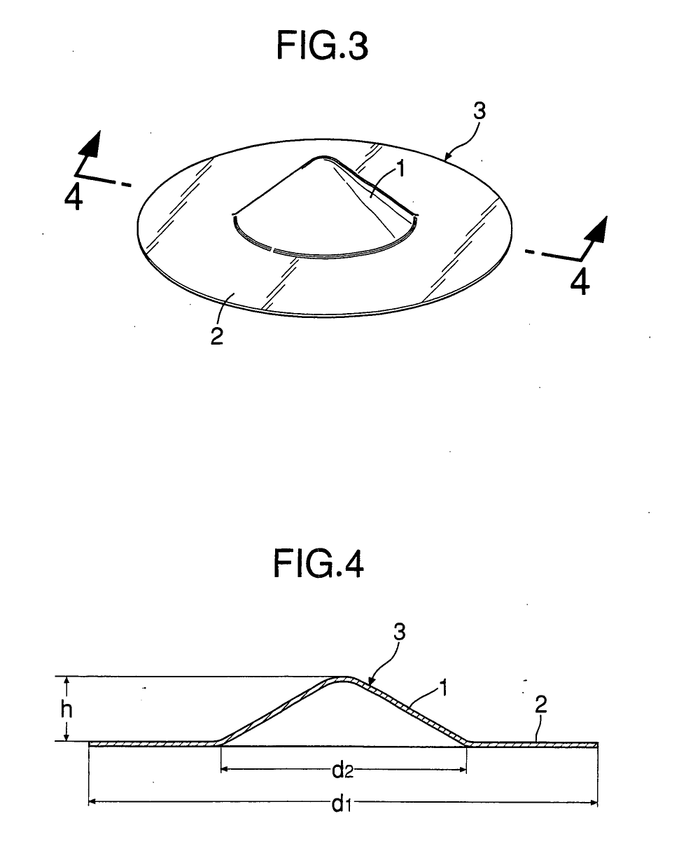

Further, circular blanks each having a diameter of 84 mm were punched from the examples 8 to 13 of the Al alloy plates, respectively, and then subjected to a drawing to provide examples 8 to 13 of molded articles 3 each comprising a conical portion 1 and a flange portion 2 connected to a peripheral edge of the conical portion 1, as shown in FIG. 3. These examples 8 to 13 correspond to the examples 8 to 13 of the Al alloy plates, respectively. In each of the molded articles 3, the flange portion 2 has a outside diameter d₁ of 84 mm, and the conical portion 1 has a maximum inside diameter d₂ of 40 mm and a depth of 13 mm.

Thereafter, the examples 8 to 13 of the molded articles were subjected to a washing treatment, then subjected to an electro-deposition coating using a solvent-type coating (made under a trade name of HG-350E by Kansai Paint Co., Ltd.) and subsequently subjected to a bake drying treatment at 180° C. for 1 hour.

A visual examination for the examples 8 to 13 of the molded articles was carried out in regard to the presence or absence of a ridging mark on an outer surface of the conical portion 1. Table 4 shows contents of Mg₂Si, 0.2% bearing strengths (P₁), (P₂) before and after the heating, bake-hard amounts (P₂)-(P₁), crystal grain sizes d and the presence or absence of ridging marks for the examples 8 to 13 of the molded articles (Al alloy plates) 3.

TABLE 4

| | | 0.2% bearing | | | | |
|---|---|---|---|---|---|---|
| | | strength | | | | |
| | Content | (MPa) | | | | |
| Formed | of | | After | Bake-hard | Crystal | Presence |
| part | Mg₂Si | Before | heat- | amount | grain | or absence |
| (Al alloy | (% by | heating | ing | (P₂) − (P₁) | size d | of ridging |
| plate) | weight) | (P₁) | (P₂) | (MPa) | (μm) | mark |
| Example 8 | 0.87 | 117 | 182 | 65 | 20 | Absence |
| Example 9 | 0.87 | 124 | 195 | 71 | 16 | Absence |
| Example 10 | 0.87 | 120 | 181 | 61 | 20 | Absence |
| Example 11 | 0.87 | 126 | 204 | 78 | 17 | Absence |
| Example 12 | 0.87 | 125 | 200 | 75 | 18 | Absence |
| Example 13 | 1.31 | 148 | 177 | 29 | 27 | Presence |

As is apparent from Tables 3 and 4, if the contents of Si and Mg are specified as described above as in the examples 8 to 12 and moreover, Fe, Cr, Ti and B which are selected chemical constituents are contained in particular amounts as described above, it is possible to prevent the generation of a ridging mark due to the press-drawing, thereby producing a smooth coated surface. In the example 13 of the molded article 3, a coated surface was rough.

If example 4 in Tables 1 and 2 is compared with example 8 in Tables 3 and 4, an increase in strength due to the pulverization of the crystal grain can e seen. In addition, if example 8 is compared with example 9, a strength-increasing effect provided by Cu can be seen.

1. An aluminum alloy plate which is used for producing a molded article to be subjected to a bake coating, comprising silicon (Si), magnesium (Mg), aluminum (Al) and inevitable impurities,
wherein when the Si content by weight percent is taken on an x-axis of rectangular coordinates and the Mg content by weight percent is taken on a y-axis of the rectangular coordinates, the Si and Mg contents are set in a region in a diagram formed by sequentially connecting a point A (0.18, 0.31), a point B (1.3, 0.31), a point C (1.3, 0.64), a point D (0.37, 0.64), a point E (0.37, 1.0), a point F (0.18, 1.0) and the point A (0.18, 0.31).

2. An aluminum alloy plate which is used for producing a molded article to be subjected to a bake coating, comprising silicon (Si) and magnesium (Mg) as requisite chemical constituents and further contains at least one of Fe, Ti, B and Cr as an optional chemical constituent, with the balance being aluminum (Al) containing inevitable impurities,
wherein when the Si content by weight percent is taken on an x-axis of rectangular coordinates and the Mg content by weight percent is taken on a y-axis of the rectangular coordinates, the Si and Mg contents are set in a region in a diagram formed by sequentially connecting a point A (0.18, 0.31), a point B (1.3, 0.31), a point C (1.3, 0.64), a point D (0.37, 0.64), a point E (0.37, 1.0), a point F (0.18, 1.0) and the point A (0.18, 0.31); and the Fe content is set in a range of 0.2% by weight≦Fe≦0.6% by weight; the Ti content is set in a range of 0.01% by weight≦Ti≦0.2% by weight; the B content is set in a range of 0.0005% by weight≦B≦0.05% by weight; and the Cr content is set in a range of 0.03% by weight≦Cr≦0.2% by weight.

3. An aluminum alloy plate which is used for producing a molded article to be subjected to a bake coating, comprising silicon (Si), magnesium (Mg) and copper (Cu) as requisite chemical constituents and further contains at least one of Fe, Ti, B and Cr as an optional chemical constituent, with the balance being aluminum (Al) containing inevitable impurities,
wherein when the Si content by weight percent is taken on an x-axis of rectangular coordinates and the Mg content by weight percent is taken on a y-axis of the rectangular coordinates, the Si and Mg contents are set in a region in a diagram formed by sequentially connecting a point A (0.18, 0.31), a point B (1.3, 0.31), a point C (1.3, 0.64), a point D (0.37, 0.64), a point E (0.37, 1.0), a point F (0.18, 1.0) and the point A (0.18, 0.31); and the Cu content is set at Cu≦0.2% by weight; the Fe content is set in a range of 0.2% by weight≦Fe≦0.6% by weight; the Ti content is set in a range of 0.01% by weight≦Ti≦0.2% by weight; the B content is set in a range of 0.0005% by weight≦B≦0.05% by weight; and the Cr content is set in a range of 0.03% by weight≦Cr≦0.2% by weight.

4-6. (canceled)
